(19) United States
(12) Patent Application Publication
(10) Pub. No.: US 2008/0010546 A1
(43) Pub. Date: Jan. 10, 2008

(54) Bus watch circuit

(76) Inventors: Masaharu Fukuma, Osaka (JP); Yoshimasa Nakahi, Osaka (JP)

Correspondence Address: MCDERMOTT WILL & EMERY LLP, 600 13TH STREET, NW, WASHINGTON, DC, 20005-3096, US

(21) Appl. No.: 11/808,041

(22) Filed: Jun. 6, 2007

(30) Foreign Application Priority Data
Jun. 6, 2006 (JP) 2006-157123

(51) Int. Cl. G06F 11/00

(52) U.S. Cl. 714/39

(57) ABSTRACT

A debug-target block outputs input data received from a bus as output data and generates input data effective timing information representing an effective timing of the input data and output data effective timing information representing an effective timing of the output data. A control circuit generates a retention timing signal representing a timing of internally retaining the input data and a comparison timing signal representing a timing of comparing the input data and the output data based on the input data effective timing information and the output data effective timing information. A data retaining circuit retains the input data in synchronization with the retention timing signal. An inconsistency detecting circuit judges whether or not the retained data of the data retaining circuit and the output data are consistent in synchronization with the comparison timing signal.

### BACKGROUND OF THE INVENTION

1. Field of the Invention

The present invention relates to a bus watch circuit suitably used for debug of a system and evaluation/improvement of an application performance in an information processing device or the like.

2. Description of the Related Art

When an operation of a bus is verified according to conventional debug methods such as the on-chip debugger (OCD) and the in-circuit emulator (ICE), trace information is outputted outside for the debug. Further, as shown in Japanese Patent Documents (Japanese Patent Laid-Open No. H05-324495) a method is also available in which protocol transition information is stored in advance in a memory device and compared to detect if protocols are illegally used.

When operations of a plurality of buses are verified according to the conventional debug methods such as the on-chip debugger (OCD) and the in-circuit emulator (ICE), a large number of terminals are necessary in order to output the trace information outside. However, there is a limit to the number of the terminals which can be provided, and it is thereby difficult to watch two or more pieces of internal information. Further, a complicated circuit configuration makes it difficult to identify a section where such a problem as garbled data arises due to the influence of a physical failure or crosstalk. According to a method in which the protocol transition information is stored in advance in a memory device, any illegality in the protocol transition can be detected, however, the section where such a problem as garbled data is generated cannot be detected.

### SUMMARY OF THE INVENTION

Therefore, a main object of the present invention is to make it possible to easily identify a section where such a problem as garbled data arises without referring to trace information, thereby reduce steps for analyzing the problem, and execute a number of verifications with a fewer number of terminals.

1) A bus watch circuit according to the present invention comprises:

a debug-target block for outputting input data received from a bus as output data and generating input data effective timing information representing an effective timing of the input data and output data effective timing information representing an effective timing of the output data;

a control circuit for generating a retention timing signal representing a timing of internally retaining the input data and a comparison timing signal representing a timing of comparing the input data and the output data based on the input data effective timing information and the output data effective timing information;

a data retaining circuit for retaining the input data in synchronization with the retention timing signal; and

an inconsistency detecting circuit for judging whether or not the retained data of the data retaining circuit and the output data are consistent in synchronization with the comparison timing signal.

In the foregoing constitution, when the input data on the bus is inputted to the debug-target block, the debug-target block receives the input data and outputs it to the bus, and further, outputs the input data effective timing information representing the effective timing of the input data and the output data effective timing information representing the effective timing of the output data to the control circuit. As a result, the control circuit generates the retention timing signal and the comparison timing signal, and then outputs the retention timing signal to the data retaining circuit while outputting the comparison timing signal to the inconsistency detecting circuit. The data retaining circuit retains the input data with respect to the debug-target block in synchronization with the retention timing signal and then outputs the retained data to the inconsistency detecting circuit. The inconsistency detecting circuit judges whether or not the retained data of the data retaining circuit and the output data from the debug-target block are consistent in synchronization with the comparison timing signal from the control circuit.

According to the foregoing constitution wherein the input data of the debug-target block and the output data are compared in real time, a section where such a problem as garbled data arises can be easily identified without referring to the trace information as in the conventional technology, and the number of steps for analyzing the problem can be there by reduced. Further, a number of verifications can be performed with a fewer number of terminals because it becomes unnecessary to output the trace information as in the conventional technology.

2) As another mode of the constitution in 1), the bus watch circuit further comprises an access information calculating circuit for calculating latency in the debug-target block and an access frequency of the input data with respect to the debug-target block based on the retention timing signal and the comparison timing signal.

According to the foregoing constitution, the access information calculating circuit calculates the latency (transmission delay between the input timing of the input data and the output timing of the output data) and outputs the calculation result in the form of a latency signal, and further, calculates the access frequency with respect to the debug-target block and outputs the calculation result in the form of an access frequency signal, based on the retention timing signal and the comparison timing signal from the control circuit. When the latency and the access number in the debug-target block are thus evaluated in the evaluation of an application performance, a section which is a bottleneck can be detected. As a result, the foregoing constitution is useful in improving the application performance.

3) A bus watch circuit according to the present invention, in the constitution in 1), may further comprise a data processing circuit interposed between the data retaining circuit and the inconsistency detecting circuit. More specifically, the bus watch circuit comprises:

a debug-target block for executing an arbitrary data processing on input data received from a bus and outputting a processing result thus obtained as output data, the debug-target block further generating input data effective timing information representing an effective timing of the input data, output data effective timing information representing an effective timing of the output data, and data processing information relating to the arbitrary data processing;

a control circuit for generating a retention timing signal representing a timing of internally retaining the input data, a comparison timing signal representing a comparison timing of the output data and a data processing control signal based on the input data effective timing information, the output data effective timing information and the data processing information;

a data retaining circuit for retaining the input data in synchronization with the retention timing signal;

a data processing circuit for executing the arbitrary data processing on the retained data of the data retaining circuit based on the data processing control signal; and

an inconsistency detecting circuit for judging whether or not the processed data of the data processing circuit and the output data are consistent in synchronization with the comparison timing signal.

In the foregoing constitution, the data retaining circuit retains the input data, the data processing circuit executes the arbitrary data processing on the retained data, and the inconsistency detecting circuit compares the resulting processed data to the output data. In this case, when the data processing circuit is configured to have a function equal to the data processing executed on the input data by the debug-targeted block, the resulting processed data of the data processing circuit on which the data processing result of the debug-target block is reflected can be compared to the output data in real time. Accordingly, a section where such a problem as garbled data arises can be easily identified without referring to the trace information, which reduces the number of steps for analyzing the problem and the number of the terminals.

4) A bus watch circuit according to the present invention, in the constitution in 1), may handle a plurality of input data. More specifically, the bus watch circuit according to the present invention comprises:

a debug-target block for receiving effective input data from a group of input data inputted from different buses and outputting the received input data as output data, the debug-target block further generating input data effective timing information representing an effective timing of the effective input data, output data effective timing information representing an effective timing of the output data, and effective data instruction information for instructing the effective input data in the group of input data;

a control circuit for generating a retention timing signal representing a timing of internally retaining the effective input data, a comparison timing signal representing a comparison timing of the output data and an effective data selection signal for instructing the effective input data based on the input data effective timing information, the output data effective timing information and the effective data instruction information;

a data retaining circuit for selecting and retaining the effective input data from the group of input data in synchronization with the retention timing signal based on the effective data selection signal; and

an inconsistency detecting circuit for judging whether or not the retained data of the data retaining circuit and the output data are consistent in synchronization with the comparison timing signal.

In the foregoing constitution, the debug-target block is configured to input the plurality of data from the different buses. The debug-target block generates the effective data instruction information representing the effective input data, and the control circuit generates the effective data selection signal based on the generated effective data instruction information and outputs the generated signal to the data retaining circuit. The data retaining circuit, to which the plurality of input data are inputted, selects the effective input data from the group of input data in accordance with the effective data selection signal and retains the selected effective input data. The inconsistency detecting circuit judges whether or not the effective input data retained by the data retaining circuit and the output data are inconsistent. As the input data are retained in a time-sharing manner even in the case the group of input data from the different buses are handled, a section where such a problem as garbled data arises can be easily identified without referring to the trace information, which reduces the number of steps for analyzing the problem and the number of the terminals.

A bus watch circuit according to the present invention, in the constitution in 4), may further comprise the data processing circuit provided for each of the input data. More specifically, the bus watch circuit according to the present invention comprises:

a debug-target block for executing an arbitrary data processing set for each data on effective input data of a group of input data inputted from different buses and outputting a processing result thus obtained as output data, the debug-target block further generating input data effective timing information representing an effective timing of the effective input data, output data effective timing information representing an effective timing of the output data, effective data instruction information for instructing the effective input data in the group of input data, and data processing information relating to the arbitrary data processing;

a control circuit for generating a retention timing signal representing a timing of internally retaining the effective input data, a comparison timing signal representing a comparison timing of the output data, an effective data selection signal for instructing the effective input data, and a group of data processing control signals relating to the arbitrary data processing corresponding to each of the input data based on the input data effective timing information, the output data effective timing information, the effective data instruction information, and the data processing information;

a data retaining circuit for selecting and retaining the effective input data from the group of input data in synchronization with the retention timing signal based on the effective data selection signal;

a group of data processing circuits for executing the arbitrary data processing corresponding to one of the group of input data on the retained data of the data retaining circuit based on the group of data processing control signals, the number of data processing circuits provided being equal to the number of the input data constituting the group of input data; and

an inconsistency detecting circuit for judging whether or not the effective processed data of the group of processed data data-processed by the group of data processing circuits and the output data are consistent in synchronization with the comparison timing signal.

In the foregoing constitution, the group of data processing circuits are provided, and the data retained by the group of data retaining circuits are inputted to the data processing circuits corresponding to the respective input data. Provided that the debug-target block has a function equal to each data processing executed on each of the group of input data, an arbitrary data processing circuit receives the effective input data corresponding thereto from the data retaining circuit when the input data is judged to be effective. Then, the arbitrary data processing circuit executes the arbitrary data processing on the input data to thereby generate the processed data on which the result of particular data processing executed on the input data by the debug-target block is reflected. Further, another arbitrary data processing circuit receives the effective input data corresponding thereto from the data retaining circuit when the input data is judged to be effective. Then, said another arbitrary data processing circuit executes another arbitrary data processing on the input data to thereby generate the processed data on which the result of another particular data processing executed on the input data by the debug-target block is reflected. Thus, even in the case where the plurality of input data from the different buses are handled, the input data are retained in a time-sharing manner, and the processing result of the data processing circuit on which the data processing result in the debug-target block is reflected can be compared to the output data in real time. As a result, a section where such a problem as garbled data arises can be easily identified without referring to the trace information, which reduces the number of steps for analyzing the problem and the number of the terminals.

6) A bus watch circuit according to the present invention, in the constitution in 4), may comprise the data retaining circuit provided for each of the input data. More specifically, the bus watch circuit according to the present invention comprises:

a debug-target block for separately receiving each data of a group of input data inputted from different buses and outputting the received input data as output data, the debug-target block further generating input data effective timing information representing an effective timing of each of the input data and output data effective timing information representing an effective timing of the output data;

a control circuit for generating a retention timing signal representing a timing of internally retaining the input data and a comparison timing signal representing a timing of comparing the input data and the output data for each of the input data based on the input data effective timing information and the output data effective timing information;

a group of data retaining circuits for separately retaining each of the input data in synchronization with the retention timing signal, the number of the data retaining circuits provided being equal to the number of the input data constituting the group of input data;

an inconsistency detecting circuit for judging whether or not retained data of each of the data retaining circuits and the output data are consistent in synchronization with the comparison timing signal.

In the foregoing constitution wherein the plurality of data retaining circuits corresponding to the number of the input data are provided, the plurality of input data which are close to each other in terms of timing can be retained even when the debug-target block chronologically executes the data processing on the plurality of input data. Accordingly, the inconsistency detecting circuit for comparing the retained data to the output data can be shared by the plurality of input data. As a result, a section where such a problem as garbled data arises can be easily identified without referring to the trace information, which reduces the number of steps for analyzing the problem and the number of the terminals.

7) A bus watch circuit according to the present invention, in the constitution in 6), may comprise the inconsistency detecting circuit provided for each of the input data. More specifically, the bus watch circuit according to the present invention comprises:

a debug-target block for separately receiving each input data of a group of input data inputted from different buses and outputting the received input data as a group of output data, the debug-target block further generating input data effective timing information representing an effective timing of each of the input data and output data effective timing information representing an effective timing of each of the output data;

a control circuit for generating a retention timing signal representing a timing of internally retaining the input data and a comparison timing signal representing a timing of comparing the input data and the output data for each of the input data based on the input data effective timing information and the output data effective timing information;

a group of data retaining circuits for separately retaining each of the input data in synchronization with the retention timing signal, the number of the data retaining circuits provided being equal to the number of the input data constituting the group of input data;

a group of inconsistency detecting circuits for judging whether or not the retained data of each of the data retaining circuits and the output data are consistent in synchronization with the comparison timing signal, the number of the inconsistency detecting circuits provided being equal to the number of the input data constituting the group of input data.

In the foregoing constitution, the plurality of data retaining circuits and the plurality of inconsistency detecting circuits, which respectively correspond to the number of the input data, are provided. Therefore, even in the case where the debug-target block simultaneously executes the data processing on the plurality of input data, the data processing can be simultaneously watched in real time. As a result, a section where such a problem as garbled data arises can be easily identified without referring to the trace information, which reduces the number of steps for analyzing the problem and the number of the terminals.

8) The bus watch circuit according to the present invention may further comprise, in the constitution in 7), a group of access information calculating circuits for calculating latency in the debug-target block and an access frequency of the input data with respect to the debug-target block based on the retention timing signal and the comparison timing signal, wherein

the number of the access information calculating circuits provided corresponds to the number of the input data constituting the group of input data.

In the foregoing constitution, the latency and the access frequency in the debug-target block can be simultaneously observed for each of the input data. As a result, a section where such a problem as garbled data arises can be easily identified without referring to the trace information, which reduces the number of steps for analyzing the problem and the number of the terminals.

9) A bus watch circuit according to the present invention, in the constitution in 6), may comprise the data processing circuit for each of the input data. More specifically, the bus watch circuit according to the present invention comprises:

a debug-target block for separately executing an arbitrary data processing on each of input data constituting a group of input data inputted from different buses and outputting a processing result thus obtained as output data, the debug-target block further generating input data effective timing information of each of the input data, output data effective timing information of the output data, and data processing information relating to the arbitrary data processing corresponding to each of the input data;

a control circuit for generating a retention timing signal representing a timing of internally retaining the input data, a comparison timing signal representing a comparison timing of the output data, and a data processing control signal relating to the arbitrary data processing corresponding to each of the input data for each of the input data based on the input data effective timing information, the output data effective timing information and the data processing information;

a group of data retaining circuits for retaining the input data in synchronization with the retention timing signal, the number of the data retaining circuits provided being equal to the number of the input data constituting the group of input data;

a group of data processing circuits for executing the arbitrary data processing on the retained data of each of the data retaining circuits based on each of the data processing control signals, the number of the data processing circuits provided being equal to the number of the input data constituting the group of input data; and

an inconsistency detecting circuit for judging whether or not the processed data of each of the data processing circuits and the output data are consistent in synchronization with the comparison timing signal.

In the foregoing constitution wherein the plurality of data retaining circuits and the plurality of data processing circuits, which respectively correspond to the number of the input data, are provided, the plurality of input data which are close to each other in terms of timing can be retained even when the data processing with respect to the plurality of input data is chronologically executed in the debug-target block. Accordingly, the inconsistency detecting circuit can be shared by the plurality of input data. Further, the processed data and the output data can be compared in real time. As a result, the section where such a problem as garbled data arises can be easily identified without referring to the trace information, which reduces the number of steps for analyzing the problem and the number of the terminals.

10) A bus watch circuit according to the present invention, in the constitution in 9), may comprise the inconsistency detecting circuit for each of the input data. More specifically, the bus watch circuit according to the present invention comprises:

a debug-target block for separately executing an arbitrary data processing on each of input data constituting a group of input data inputted from different buses and outputting a processing result thus obtained as a group of output data for each of the input data, the debug-target block further generating input data effective timing information of each of the input data, output data effective timing information of each of the output data, and data processing information relating to the arbitrary data processing corresponding to each of the input data;

a control circuit for generating a retention timing signal representing a timing of internally retaining the input data, a comparison timing signal representing a comparison timing of the output data, and a data processing control signal relating to the arbitrary data processing corresponding to each of the input data for each of the input data based on the input data effective timing information, the output data effective timing information and the data processing information;

a group of data retaining circuits for retaining the input data in synchronization with the retention timing signal, the number of the data retaining circuits provided being equal to the number of the input data constituting the group of input data;

a group of data processing circuits for executing the arbitrary data processing on the retained data of each of the data retaining circuits based on each of the data processing control signals, the number of the data processing circuits provided being equal to the number of the input data constituting the group of input data; and

a group of inconsistency detecting circuits for judging whether or not the processed data of each of the data processing circuits and the output data are consistent in synchronization with the comparison timing signal, the number of the inconsistency detecting circuits provided being equal to the number of the input data constituting the group of input data.

In the foregoing constitution wherein the plurality of data retaining circuits, the plurality of data processing circuits, and the plurality of inconsistency detecting circuits, which respectively correspond to the number of the input data, are provided, processing of a plurality of data can be simultaneously watched in real time even when the data processing with respect to the plurality of input data are simultaneously executed in the debug-target block. Further, the processed data resulting from the data processing in the data processing circuit on which the data processing result in the debug-target block is reflected can be compared to the output data in real time. As a result, a section where such a problem as garbled data arises can be easily identified without referring to the trace information, which reduces the number of steps for analyzing the problem and the number of the terminals.

11) The bus watch circuit according to the present invention, in the constitution in 10), may further comprise a group of access information calculating circuits for calculating latency in the debug-target block and an access frequency with respect to the debug-target block based on the retention timing signal and the comparison timing signal, wherein

the number of the access information calculating circuits provided corresponds to the number of the input data constituting the group of input data.

In the foregoing constitution, the latency and the access frequency in the debug-target block can be simultaneously observed for each of the input data. As a result, a section where such a problem as garbled data arises can be easily identified without referring to the trace information, which reduces the number of steps for analyzing the problem and the number of the terminals.

12) An information processing inspecting system comprising any of the bus watch circuits recited in 1)-11) is effective.

According to the present invention wherein the correlation between the input and the output with respect to the debug-target block can be watched in real time, a section where such a problem as garbled data arises can be easily identified without referring to the trace information as in the conventional technology, which reduces the number of steps for analyzing the problem. Further, in the present invention wherein the inconsistency detection signal showing the comparison result is outputted, the output of the trace information, which was conventionally adopted, becomes unnecessary. As a result, a number of verifications can be performed with a fewer number of terminals.

Furthermore, the latency and the access frequency in the debug-target block are evaluated, so that any section which is a bottleneck can be detected. Therefore, the evaluation is useful for the improvement of the application performance.

The bus watch circuit according to the present invention is useful when, for example, any failure of a system used in an information processing device or the like is analyzed. The bus watch circuit according to the present invention, which is capable of detecting the latency, is useful also in the evaluation and improvement of the application performance.

### BRIEF DESCRIPTION OF THE DRAWINGS

The above described and other objects of the invention will become clear by the following description of preferred embodiments of the invention and be stated clearly in the appended claims. A number of benefits not recited in this specification will come to the attention of the skilled in the art upon the implementation of the present invention.

FIG. 1 is a block diagram illustrating a constitution of a bus watch circuit according to a preferred embodiment 1 of the present invention.

FIG. 2 is a block diagram illustrating a constitution of a bus watch circuit according to a preferred embodiment 2 of the present invention.

FIG. 3 is a block diagram illustrating a constitution of a bus watch circuit according to a preferred embodiment 3 of the present invention.

FIG. 4 is a block diagram illustrating a constitution of a bus watch circuit according to a preferred embodiment 4 of the present invention.

FIG. 5 is a block diagram illustrating a constitution of a bus watch circuit according to a preferred embodiment 5 of the present invention.

FIG. 6 is a block diagram illustrating a constitution of a bus watch circuit according to a preferred embodiment 6 of the present invention.

FIG. 7 is a block diagram illustrating a constitution of a bus watch circuit according to a preferred embodiment 7 of the present invention.

FIG. 8 is a block diagram illustrating a constitution of a bus watch circuit according to a preferred embodiment 8 of the present invention.

### DETAILED DESCRIPTION OF THE INVENTION

Hereinafter, preferred embodiments of a bus watch circuit according to the present invention are described in detail referring to the drawings.

### Preferred Embodiment 1

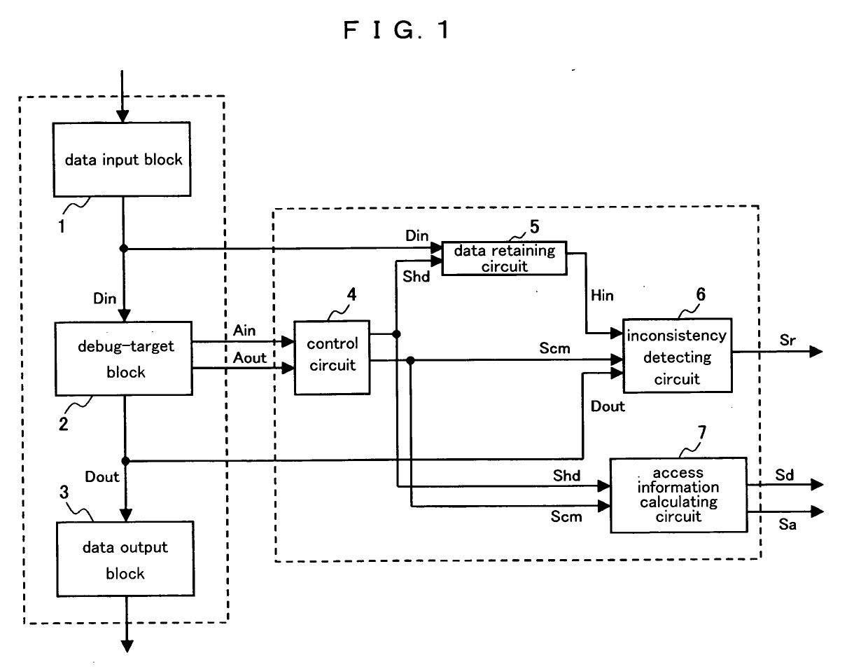

FIG. 1 is a block diagram illustrating a constitution of a bus watch circuit according to a preferred embodiment 1 of the present invention. The bus watch circuit comprises a data input block 1 for fetching data on the bus and outputting the fetched data as input data Din, a debug-target block 2 for receiving the input data Din and outputting it as output data Dout, a data output block 3 for transmitting the output data Dout outside, a control circuit 4, a data retaining circuit 5 for retaining the input data Din, an inconsistency detecting circuit 6 for detecting whether or not the input data Din and the output data Dout are consistent, and an access information calculating circuit 7 for calculating latency (transmission delay) and an access frequency in the debug-target block 2.

The data input block 1 may accept the data from the bus as they are and output the same data as the input data Din or may process the data from the bus and output the processed data as the input data Din. Alternately, the data input block 1 itself may generate data therein irrespective of the data on the bus and output the generated data as the input data Din. The data output block 3 may output the output data Dout outside as they are, or may process the output data Dout and output the processed data. These options are applied to preferred embodiments 2-8 described later.

The debug-target block 2 receives the input data Din. Then, the debug-target block 2 outputs the received input data Din as the output data Dout to the data output block 3 and the inconsistency detecting circuit 6. The debug-target block 2 further outputs input data effective timing information Ain representing an effective timing of the input data Din and output data effective timing information Aout representing an effective timing of the output data Dout to the control circuit 4.

The control circuit 4 is supplied with the input data effective timing information Ain and the output data effective timing information Aout from the debug-target block 2. The control circuit 4 generates a retention timing signal Shd based on the input data effective timing information Ain and outputs the generated signal to the data retaining circuit 5 and the access information calculating circuit 7. The control circuit 4 further generates a comparison timing signal Scm based on the output data effective timing information Aout and outputs the generated signal to the inconsistency detecting circuit 6 and the access information calculating circuit 7.

The data retaining circuit 5 retains the input data Din supplied to the debug-target block 2 in synchronization with the retention timing signal Shd from the control circuit 4, and then, outputs retained data Hin to the inconsistency detecting circuit 6.

The inconsistency detecting circuit 6 judges whether or not the retained data Hin retained by the data retaining circuit 5 and the output data Dout outputted by the debug-target block 2 are consistent in synchronization with the comparison timing signal Scm supplied from the control circuit 4. The inconsistency detecting circuit 6 outputs an inconsistency detection signal Sr when it is judged that the two data are inconsistent.

The access information calculating circuit 7 calculates the latency which is a time length required from the input of the input data Din until the output of the output data Dout by the debug-target block 2. This calculating process is performed in synchronization with the retention timing signal Shd and the comparison timing signal Scm outputted by the control circuit 4. The access information calculating circuit 7 outputs a result of the calculation as a latency signal Sd. The access information calculating circuit 7 further calculates the number of times the debug-target block 2 was accessed. This calculating process is performed based on the comparison timing signal Scm. The access information calculating circuit 7 outputs a result of the calculation as an access frequency signal Sa.

Next, operation of the bus watch circuit according to the present preferred embodiment thus constituted is described. When the input data Din from an external bus is fetched by the data input block 1, the data input block 1 outputs the input data Din to the debug-target block 2 and the data retaining circuit 5. The debug-target block 2 receives the input data Din, and outputs the received input data Din as the output data Dout to the data output block 3 and the inconsistency detecting circuit 6. At the time, the debug-target block 2 generates the input data effective timing information Ain representing the effective timing of the input data Din and the output data effective timing information Aout representing the effective timing of the output data Dout and outputs the generated information to the control circuit 4.

The control circuit 4 generates the retention timing signal Shd based on the input data effective timing information Ain and outputs the generated signal to the data retaining circuit 5. The control circuit 4 further generates the comparison timing signal Scm based on the output data effective timing information Aout and outputs the generated signal to the inconsistency detecting circuit 6 and the access information calculating circuit 7. The comparison timing signal Scm controls the timing of comparing the retained data Hin retained by the data retaining circuit 5 and the output data Dout outputted by the debug-target block 2.

The data retaining circuit 5 retains the input data Din inputted to the debug-target block 2 in synchronization with the retention timing signal Shd outputted by the control circuit 4. The data retaining circuit 5 outputs the retained data Hin to the inconsistency detecting circuit 6.

The inconsistency detecting circuit 6 judges whether or not the retained data Hin retained by the data retaining circuit 5 and the output data Dout outputted by the debug-target block 2 are consistent in synchronization with the comparison timing signal Scm supplied from the control circuit 4. The inconsistency detecting circuit 6 outputs the inconsistency detection signal Sr when the two data are judged to be inconsistent.

The access information calculating circuit 7 calculates the latency (transmission delay) which is the time length required between the input of the input data Din and the output of the output data Dout by the debug-target block 2. This calculating process is performed in synchronization with the retention timing signal Shd and the comparison timing signal Scm. The access information calculating circuit 7 outputs the calculation result as the latency signal Sd. The access information calculating circuit 7 further calculates the number of times the debug-target block 2 was accessed. This calculating process is performed based on the comparison timing signal Scm. The access information calculating circuit 7 outputs the calculation result as the access frequency signal Sa.

According to the present preferred embodiment, the input and output buses of the debug-target block 2 are watched, and the input data Din on the input bus and the output data Dout on the output bus are compared in real time in the inconsistency detecting circuit 6. Accordingly, a correlation between the input and the output in the debug-target block 2 can be observed in real time. As a result, a section where such a problem as garbled data arises can be easily identified without referring to trace information as in the conventional technology.

Further, the number of steps for analyzing the problem can be reduced, and the output of the trace information, which was adopted in the conventional technology, becomes unnecessary because the inconsistency detection signal Sr representing the comparison result is outputted. As a result, a number of verifications can be performed with a fewer number of terminals. [481 Further, the access information calculating circuit 7, which detects the latency in the debug-target block 2 required from the input of the input data Din to the debug-target block 2 until the output of the output data Dout to the output bus and the number of the accesses with respect to the debug-target block 2, is provided. Accordingly, any section which is a bottleneck in the evaluation of an application performance can be detected. Therefore, the constitution is useful for the improvement of the application performance.

### Preferred Embodiment 2

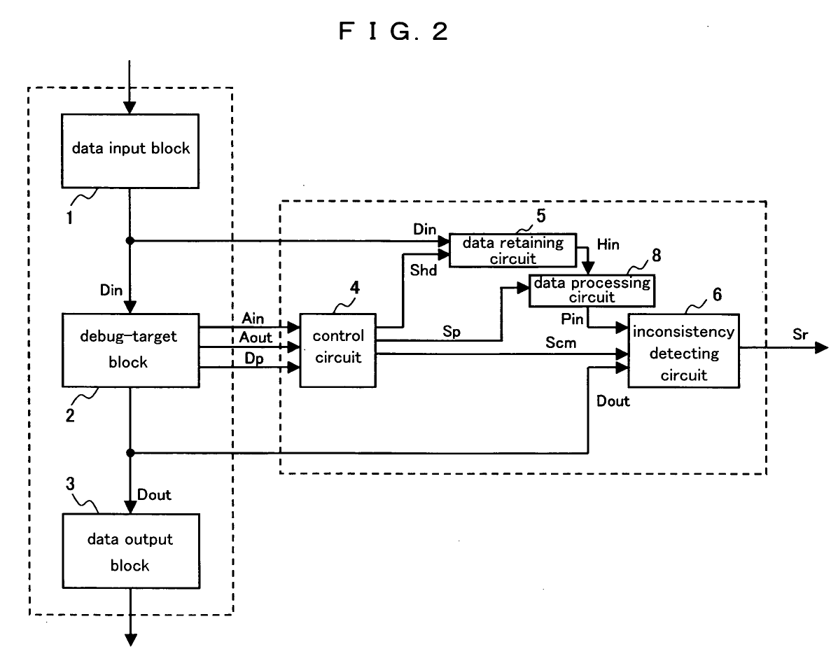

FIG. 2 is a block diagram illustrating a constitution of a bus watch circuit according to a preferred embodiment 2 of the present invention. The same reference symbols shown in FIG. 2 as those in the preferred embodiment 1 (FIG. 1) denote the same components. The constitution according to the present preferred embodiment is characterized as follows.

In the preferred embodiment 2, a data processing circuit 8 is inserted between the data retaining circuit 5 and the inconsistency detecting circuit 6. The data processing circuit 8 executes an arbitrary data processing on the retained data Hin retained by the data retaining circuit 5 and generates processed data Pin, which is a processing result thus obtained, and then, outputs the generated data to the inconsistency detecting circuit 6. The debug-target block 2 generates the input data effective timing information Ain and the output data effective timing information Aout in a manner similar to the preferred embodiment 1, and further generates a data processing information Dp relating to the arbitrary data processing executed to the input data Din and outputs the generated information to the control circuit 4. The control circuit 4 executes operation similar to that of the preferred embodiment 1, and further, outputs a data processing control signal Sp relating to the arbitrary data processing to the data processing circuit 8 based on the data processing information Dp from the debug-target block 2. The inconsistency detecting circuit 6 compares the processed data Pin and the output data Dout. This comparison process is performed in synchronization with the comparison timing signal Scm outputted by the control circuit 4. The inconsistency detecting circuit 6 outputs a result of the comparison as the inconsistency detection signal Sr. The access information calculating circuit 7, which is not shown in FIG. 2, can be provided in a manner similar to the preferred embodiment 1. The rest of the components, which are similar to those of the preferred embodiment 1, are not described again.

Next, operation of the bus watch circuit according to the present preferred embodiment thus constituted will be described. The description given below is centered on operation which is specific to the present preferred embodiment. The debug-target block 2 generates the data processing information Dp relating to the arbitrary data processing executed on the input data Din (executed by the data processing circuit 8), and outputs the generated information to the control circuit 4. The control circuit 4 generates the data processing control signal Sp relating to the arbitrary data processing based on the data processing information Dp and outputs the generated signal to the data processing circuit 8.

The data retaining circuit 5 outputs the retained data Hin thus retained to the data processing circuit 8. The data processing circuit 8 executes the arbitrary data processing on the retained data Hin based on the data processing control signal Sp. The data processing circuit 8 outputs a processing result thus obtained as the processed data Pin to the inconsistency detecting circuit 6. The rest of the operation, which is similar to that of the preferred embodiment 1, is not described again.

According to the present preferred embodiment wherein the data processing circuit 8 is interposed subsequent to the data retaining circuit 5, the processing result of the data processing circuit 8 on which the data processing result in the debug-target block 2 is reflected (processed data Pin) can be compared to the output data Dout in real time. As a result, a section where such a problem as garbled data arises can be easily identified without referring to the trace information. Further, the number of steps for analyzing the problem and the number of the terminals can be reduced in a manner similar to the preferred embodiment 1.

### Preferred Embodiment 3

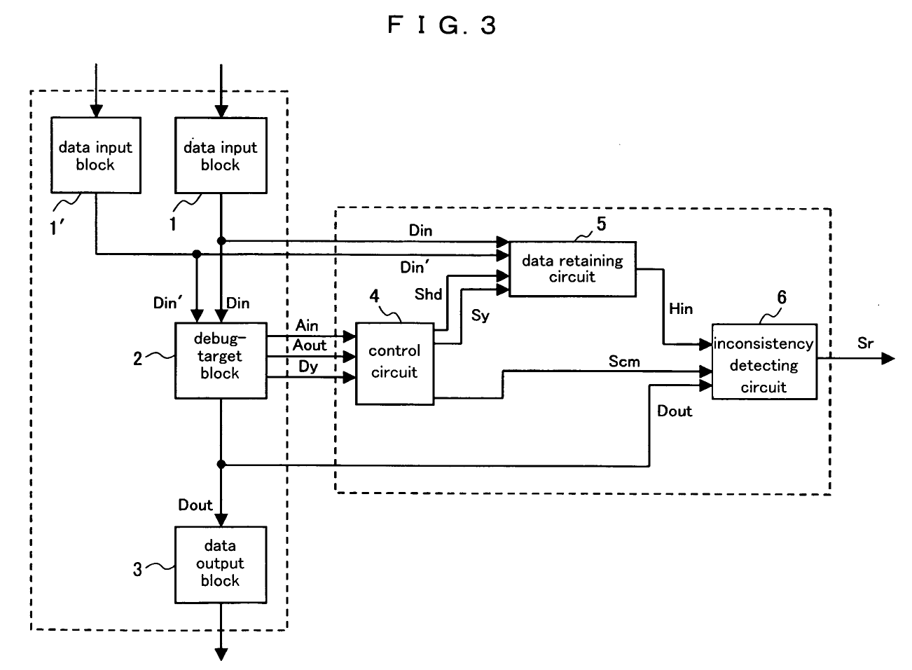

FIG. 3 is a block diagram illustrating a constitution of a bus watch circuit according to a preferred embodiment 3 of the present invention. The same reference symbols shown in FIG. 3 as those in the preferred embodiment 1 (FIG. 1) denote the same components. The constitution according to the present preferred embodiment is characterized as follows.

In the present preferred embodiment, a data input block 1′ for fetching the data on the bus and outputting it as input data Din′ is additionally provided. The debug-target block 2 receives the input data Din supplied from the data input block 1 and the input data Din′ from the data input block 1′, and places priority on one of the two data. More specifically, the debug-target block 2 outputs the prioritized data as the effective output data Dout, to the data output block 3 and the inconsistency detecting circuit 6. The debug-target block 2 also outputs the input data effective timing information Ain representing the effective timing of the input data Din or the input data Din′ and effective data instruction information Dy indicating which of the input data Di and the input data Din′ is effective to the control circuit 4. The control circuit 4 generates the effective data selection signal Sy indicating which of the input data Din and the input data Din′ is effective, in other words, which of the two data is to be retained. This signal generation process is performed based on the effective data instruction signal Dy supplied from the debug-target block 2. The control circuit 4 outputs the generated effective data selection signal S6 to the data retaining circuit 5. The data retaining circuit 5 retains one of the input data Din and the input data Din′ which is instructed as effective according to the instruction based on the effective data selection signal Sy. This data retention process is performed in synchronization with the retention timing signal Shd. The data retaining circuit 5 outputs the retained data (retained data Hin) to the inconsistency detecting circuit 6. The access information calculating circuit 7, which is not shown in FIG. 3, may be provided in a manner similar to the preferred embodiment 1. The rest of the components, which are similar to those of the preferred embodiment 1, are not described again.

The operation of the bus watch circuit according to the present preferred embodiment thus constituted will be described. When the input data Din of the two input data Din and Din′ is judged to be effective, the input data Din is retained by the data retaining circuit 5. When the input data Din′ is judged to be effective, the input data Din′ is retained by the data retaining circuit 5. The debug-target block 2 accepts the input data Din or the input data Din′. The debug-target block 2 outputs the input data Din or the input data Din′ as the output data Dout to the data output block 3 and the inconsistency detecting circuit 6. Further, the debug-target block 2 generates the input data effective timing information Ain representing the effective timing of the data to be outputted, the effective data instruction information Dy indicating which of the input data Din and the input data din′ is effective, and the output data effective timing information Aout representing the effective timing of the output data Dout, and outputs the generated information to the control circuit 4. These types of information Ain, Dy and Aout are outputted to the control circuit 4 irrespective of which of the input data Din and the input data Din′ is selected as the output data of the debug-target block 2.

The control circuit 4 generates the retention timing signal Shd and the comparison timing signal Scm, outputs the retention timing signal Shd to the data retaining circuit 5, while outputting the comparison timing signal Scm to the inconsistency detecting circuit 6. The control circuit 4 further generates the effective data selection signal Sy which instructs which of the input data Din and the input data Din′ is to be retained. The signal is generated based on the effective data instruction information Dy. The control circuit 4 outputs the generated effective data selection signal Sy to the data retaining circuit 5. The data retaining circuit 5 retains one of the input data Din and the input data Din′ which is judged to be effective according to the instruction of the effective data selection signal Sy. This data retention process is performed in synchronization with the retention timing signal Shd. The data retaining circuit 5 outputs the retained data Hin thus retained to the inconsistency detecting circuit 6. The inconsistency detecting circuit 6 compares the retained data Hin and the output data Dout. This comparison process is performed in synchronization with the comparison timing signal Scm. The inconsistency detecting circuit 6 outputs a result of the comparison as the inconsistency detection signal Sr.

According to the present preferred embodiment, the input data is retained in a time-sharing manner even when the plurality of input data from the different buses are handled, so that a section where such a problem as garbled data arises can be easily identified without referring to the trace information in a manner similar to the preferred embodiments 1 and 2. Further, the number of steps for analyzing the problem and the number of the terminals can be reduced.

### Preferred Embodiment 4

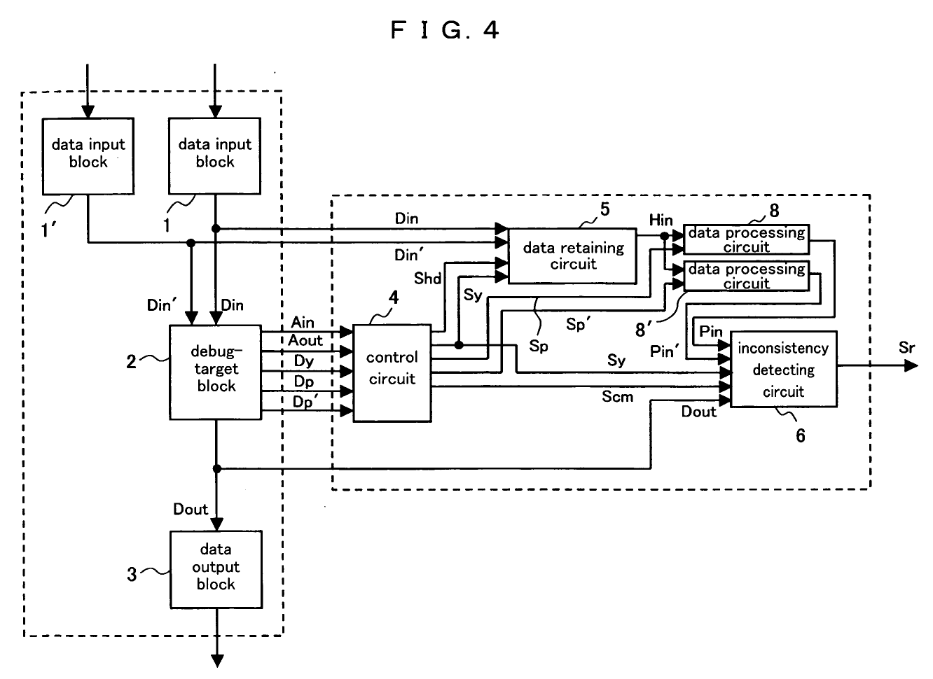

FIG. 4 is a block diagram illustrating a constitution of a bus watch circuit according to a preferred embodiment 4 of the present invention. The same reference symbols shown in FIG. 4 as those in the preferred embodiment 3 (FIG. 3) denote the same components. The constitution according to the present preferred embodiment is characterized as follows.

In the preferred embodiment 4, a plurality of data processing circuits 8 and 8′ (two in the drawing) are interposed between the data retaining circuit 5 and the inconsistency detecting circuit 6. These data processing circuits 8 and 8′ respectively correspond to the data input blocks 1 and 1′. The debug-target block 2, in a manner similar to the preferred embodiment 3, generates input data effective timing information Ain, output data effective timing information Aout, effective data instruction information Dy, and also, data processing information Dp relating to arbitrary data processing executed on the input data Din, and data processing information Dp′ relating to arbitrary data processing executed on the input data Din′, and outputs the generated information to the control circuit 4. The control circuit 4 generates the retention timing signal Shd, comparison timing signal Scm and effective data selection signal Sy in a manner similar to the preferred embodiment 3. The control circuit 4 further generates the data processing control signal Sp relating to another arbitrary data processing executed on the input data Din by the data processing circuit 8′. This signal generation process is performed based on the data processing information Dp. The control circuit 4 still further generates a data processing control signal Sp′ relating to arbitrary data processing executed on the input data Din′ by the data processing circuit 8′. The relevant signal is generated based on the data processing information Dp′. The control circuit 4 outputs the generated data processing control signals Sp and Sp′ to the corresponding data processing circuits 8 and 8′. The control circuit 4 outputs the effective data selection signal Sy, not only to the data retaining circuit 5, but also to the inconsistency detecting circuit 6. The data processing circuit 8 executes arbitrary data processing on the retained data Hin (corresponding to the input data Din) retained by the data retaining circuit 5, and outputs the processed data Pin thus obtained to the inconsistency detecting circuit 6. Arbitrary data processing described here corresponds to the processing executed on the input data Din by the debug-target block 2. The data processing circuit 8′ executes arbitrary data processing on the retained data Hin (corresponding to the input data Din′) of the data retaining circuit 5, and outputs a processed data Pin′ thus obtained to the inconsistency detecting circuit 6. Arbitrary data processing described here corresponds to the processing executed on the input data Din′ by the debug-target block 2. The rest of the components, which are similar to that of the preferred embodiment 3, is not described again.

The operation of the bus watch circuit according to the present preferred embodiment thus constituted will be described. The description given below is centered on operation which is specific to the present preferred embodiment. When the input data Din, of the two input data Din and Din′, is effective, the data retaining circuit 5 retains the input data Din. When the input data Din′ is effective, the data retaining circuit 5 retains the input data Din′. The debug-target block 2 executes arbitrary processing on one of the input data Din and the input data Din′, and generates the data processing information Dp or the data processing information Dp′ respectively corresponding to the data processing and outputs the generated information to the control circuit 4. The control circuit 4 generates the data processing control signal Sp or the data processing control signal Sp′ based on the data processing information Dp or the data processing information Dp′, and outputs the generated signal Sp or Sp′ to the data processing circuit 8 or the data processing circuit 8′.

The data processing circuit 8 executes arbitrary data processing on the retained data Hin based on the data processing control signal Sp, and outputs the processed data Pin thus obtained. The data processing circuit 8′ executes arbitrary data processing on the retained data Hin based on the data processing control signal Sp′, and outputs the processed data Pin′ thus obtained. The inconsistency detecting circuit 6 compares the processed data Pin or the processed data Pin′ to the output data Dout based on the effective data selection signal Sy, and outputs a result of the comparison as the inconsistency detection signal Sr. This comparison process is performed in synchronization with the comparison timing signal Scm.

According to the present preferred embodiment, even when the plurality of input data from the different buses are handled, the input data can be retained in the time-sharing manner, and the processed data which are the processing result of the data processing circuits 8 and 8′ on which the data processing result in the debug-target block 2 is reflected can be compared to the output data in real time. As a result, a section where such a problem as garbled data arises can be easily identified without referring to the trace information in a manner similar to the preferred embodiments 1-3. Further, the number of steps for analyzing the problem and the number of the terminals can be reduced in a manner similar to the preferred embodiments 1-3.

### Preferred Embodiment 5

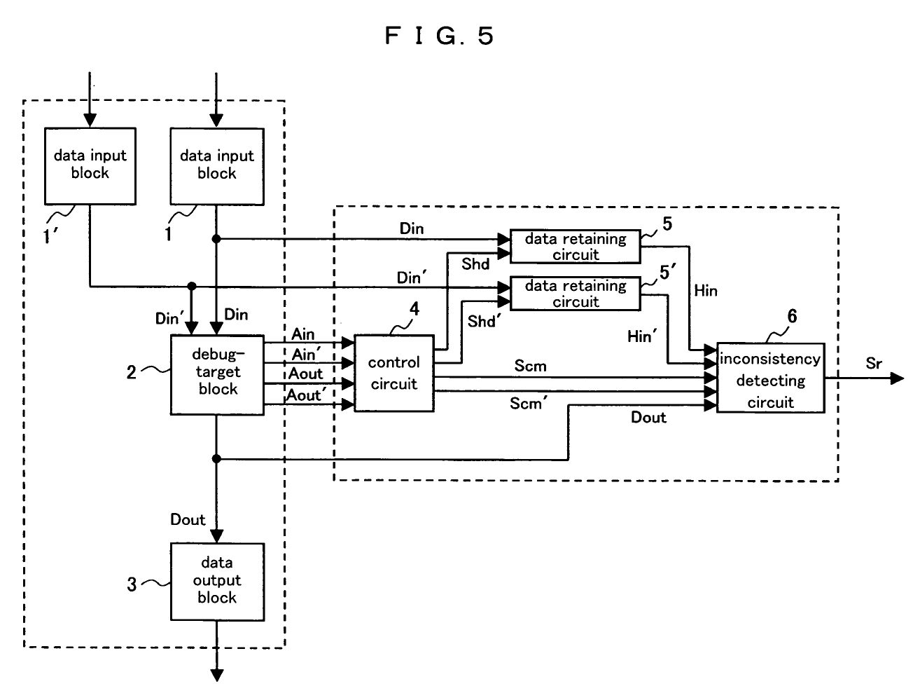

FIG. 5 is a block diagram illustrating a constitution of a bus watch circuit according to a preferred embodiment 5 of the present invention. The same reference symbols recited in FIG. 5 as those in the preferred embodiment 3 (FIG. 3) denote the same components. The constitution according to the present preferred embodiment is characterized as follows.

The preferred embodiment 5 is characterized in that a plurality of data retaining circuits (two in the drawing) are provided. The data retaining circuit 5 retains the input data Din with respect to the debug-target block 2 in synchronization with the retention timing signal Shd from the control circuit 4, while a data retaining circuit 5′ retains the input data din′ from the data input block 1′ in synchronization with the retention timing signal Shd′ from the control circuit 4. The debug-target block 2 generates the input data effective timing information Ain and Ain′ respectively corresponding to the input data Din and Din′ and the output data effective timing information Aout and Aout′ respectively corresponding to the output data Dout and Dout′ and outputs the generated information to the control circuit 4. The control circuit 4 generates the retention timing signals Shd and Shd′ and the comparison timing signals Scm and Scm′ respectively corresponding to the input data Din and Din′. The rest of the components, which are similar to those of the preferred embodiment 3, are not described again.

The operation of the bus watch circuit according to the present preferred embodiment thus constituted will be described. The description given below is centered on operation which is specific the present preferred embodiment. The input data Din inputted to the debug-target block 2 from the data input block 1 is retained by the data retaining circuit 5 in synchronization with the retention timing signal Shd outputted from the control circuit 4. The input data Din′ inputted to the debug-target block 2 from the data input block 1′ is retained by the data retaining circuit 5′ in synchronization with a retention timing signal Shd′ outputted from the control circuit 4. These steps of operation maybe simultaneously performed. The inconsistency detecting circuit 6 judges whether or not the retained data Hin retained by the data retaining circuit 5 and the output data Dout outputted from the debug-target block 2 are consistent. This judgment is performed in synchronization with the comparison timing signal Scm outputted by the control circuit 4. When the two data are judged to be inconsistent at the time, the inconsistency detecting circuit 6 outputs the inconsistency detection signal Sr. The inconsistency detecting circuit 6 further judges whether or not the retained data Hin′ retained by the data retaining circuit 5′ and the output data Dout outputted from the debug-target block 2 are consistent. This judgment is performed in synchronization with the comparison timing signal Scm′. The inconsistency detecting circuit 6 outputs the inconsistency detection signal Sr when the two data are judged to be inconsistent.

According to the present preferred embodiment wherein the data retaining circuits 5 and 5′ respectively corresponding to the two input data Din and Din′ are provided, the plurality of input data which are close to each other in terms of timing can be retained even when the data processing with respect to the plurality of input data are chronologically executed by the debug-target block 2, and the inconsistency detecting circuit 6 for comparing the input/output data can be shared by the plurality of input data. Further, a section where such a problem as garbled data arises can be easily identified without referring to the trace information though the inconsistency detecting circuit 6 can be shared, and the number of steps for analyzing the problem and the number of the terminals can be reduced.

### Preferred Embodiment 6

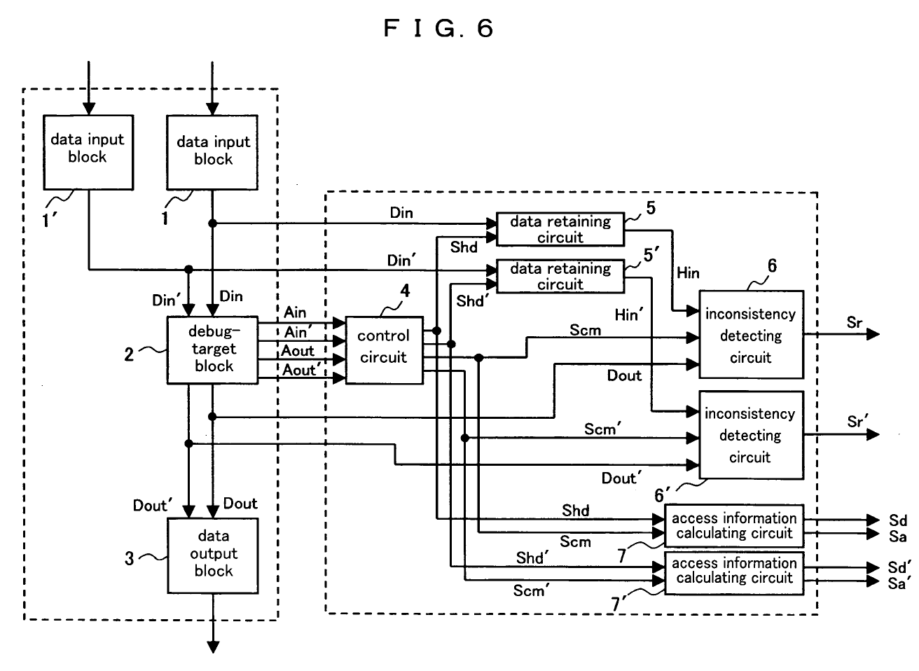

FIG. 6 is a block diagram illustrating a constitution of a bus watch circuit according to a preferred embodiment 6 of the present invention. The same reference symbols shown in FIG. 6 as those in the preferred embodiment 5 (FIG. 5) denote the same components. The constitution according to the present preferred embodiment is characterized as follows.

The preferred embodiment 6 is characterized in that a plurality of inconsistency detecting circuits (two in the drawing) are provided. The inconsistency detecting circuit 6 compares the retained data Hin retained by the data retaining circuit 5 and the output data Dout outputted by the debug-target block 2, and outputs the inconsistency detection signal Sr when the two data are inconsistent. This comparison process is performed in synchronization with the comparison timing signal Scm outputted by the control circuit 4. An inconsistency detecting circuit 6′ compares the retained data Hin′ retained by the data retaining circuit 5′ and the output data Dout′ outputted by the debug-target block 2 to each other, and outputs an inconsistency detection signal Sr′ when the two data are inconsistent with each other. The two data are compared in synchronization with the comparison timing signal Scm′ outputted by the control circuit 4. The access information calculating circuits 7 and 7′ respectively corresponding to the input data Din and Din′ are provided.

The debug-target block 2 can simultaneously accept the input data Din and the input data Din′. The control circuit 4 outputs the retention timing signals Shd and Shd′ and the comparison timing signals Scm and Scm′ in response to the two input data Din and Din′.

Next, the operation of the bus watch circuit according to the present preferred embodiment thus constituted will be described. The description given below is centered on operation which is specific to the present preferred embodiment. The input data Din inputted from the data input block 1 and the input data Din′ inputted from the data input block 1′ are simultaneously inputted to the debug-target block 2, and these data are simultaneously accepted. Further , the debug-target block 2 simultaneously outputs the output data Dout and Dout′ to the data output block 3 and the inconsistency detecting circuits 6 and 6′.

The inconsistency detecting circuit 6 judges whether or not the retained data Hin retained by the data retaining circuit 5 and the output data Dout outputted by the debug-target block 2 are consistent. This judgment is performed in synchronization with the comparison timing signal Scm outputted by the control circuit 4. The inconsistency detecting circuit 6 outputs the inconsistency detection signal Sr when the two data are judged to be inconsistent. The inconsistency detecting circuit 6′ judges whether or not the retained data Hin′ retained by the data retaining circuit 5′ and the output data Dout′ outputted by the debug-target block 2 are consistent. This judgment is performed in synchronization with the comparison timing signal Scm′ outputted by the control circuit 4. The inconsistency detecting circuit 6′ outputs the inconsistency detection signal Sr′ when the two data are judged to be inconsistent.

The access information calculating circuit 7 calculates the latency which is the time length required from the input of the input data Din to the debug-target block 2 until the output of the output data Dout by the debug-target block 2. The latency is calculated in synchronization with the retention timing signal Shd and the comparison timing signal Scm. The access information calculating circuit 7 outputs the calculation result as the latency signal Sd. Further, the access information calculating circuit 7 calculates the number of times the input data Din in the debug-block target 2 was accessed based on the comparison timing signal Scm. The access information calculating circuit 7 outputs the calculated access frequency as the access frequency signal Sa.

The access information calculating circuit 7′ calculates latency which is a time length required from the input of the input data Din′ to the debug-target block 2 until the output of the output data Dout′ by the debug-target block 2. The latency is calculated in synchronization with the retention timing signal Shd′ and the comparison timing signal Scm′. The access information calculating circuit 7′ outputs the calculation result as a latency signal Sd′. Further, the access information calculating circuit 7′ calculates the number of times the input data Din′ in the debug-block target 2 was accessed based on the comparison timing signal Scm′. The access information calculating circuit 7 outputs the calculated access frequency as an access frequency signal Sa′.

According to the present preferred embodiment wherein the data retaining circuits 5 and 5′ and the inconsistency detecting circuits 6 and 6′ respectively corresponding to the two input data Din and Din′ are provided, the input data Din and Din′ can be simultaneously watched. Further, the latency and the access frequency in the debug-target block 2 in each of the input data Din and Din′ can be simultaneously watched. Therefore, when the debug-target block 2 simultaneously accepts the plurality of input data, the flow of the plurality of input data can be watched in real time. In addition to the foregoing effect, a section where such a problem as garbled data arises can be easily identified without referring to the trace information, and the number of steps for analyzing the problem and the number of the terminals can be reduced.

### Preferred Embodiment 7

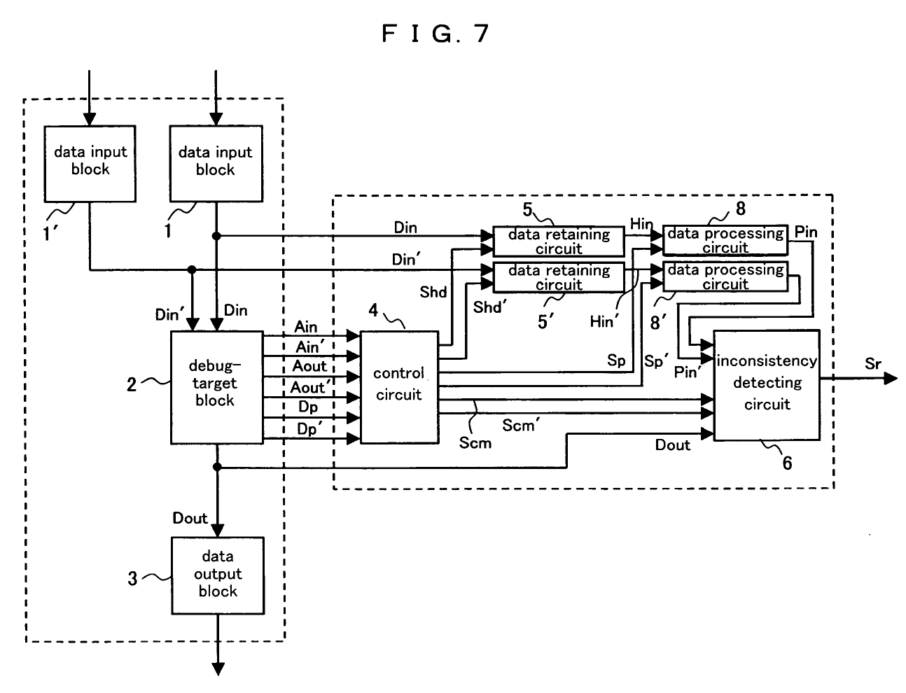

FIG. 7 is a block diagram illustrating a constitution of a bus watch circuit according to a preferred embodiment 7 of the present invention. The same reference symbols shown in FIG. 7 as those in the preferred embodiment 5 (FIG. 5) denote the same components. The constitution according to the present preferred embodiment is characterized as follows.

In the preferred embodiment 7, the data processing circuit 8 is interposed between the data retaining circuit 5 and the inconsistency detecting circuit 6, and the data processing circuit 8′ is interposed between the data retaining circuit 5′ and the inconsistency detecting circuit 6′.

The input data Din and Din′ are simultaneously inputted to the debug-target block 2, and the arbitrary data processing is executed on the prioritized input data Din. The data processing is executed by the data processing circuits 8 and 8′. The debug-target block 2 generates the input data effective timing information Ain and Ain′ and the output data effective timing information Aout and Aout′. The debug-target block 2 further generates the data processing information Dp relating to the arbitrary data processing executed on the input data Din and the data processing information Dp′ relating to the arbitrary data processing executed on the input data Din′. The debug-target block 2 outputs the various types of information thus generated to the control circuit 4.

The control circuit 4 generates the data processing control signal Sp relating to the arbitrary data processing executed on the input data Din and outputs the generated signal to the data processing circuit 8. The signal is generated based on the data processing information Dp. The control circuit 4 generates the data processing control signal Sp′ relating to the arbitrary data processing executed on the input data Din′ and outputs the generated signal to the data processing circuit 8′. The signal is generated based on the data processing information Dp′. The rest of the components, which are similar to those of the preferred embodiment 5, are not described again. [801 According to the present preferred embodiment wherein the data retaining circuits 5 and 5′ and the data processing circuits 8 and 8′ respectively corresponding to the two input data Din and Din′ are provided, the input data Din and Din′ can be simultaneously watched. Therefore, even when the data processing with respect to the plurality of input data is chronologically executed by the debug-target block 2, the plurality of input data which are close to each other in terms of timing of such data processing can be retained, and the inconsistency detecting circuit 6 for comparing the input/output data can be shared by the plurality of input data. Further, the processed data Pin and Pin′ which are the processing results of the data processing circuits 8 and 8′ on which the data processing result in the debug-target block 2 is reflected can be compared to the output data Dout in real time. In addition to the foregoing effect, a section where such a problem as garbled data arises can be easily identified without referring to the trace information, and the number of steps for analyzing the problem and the number of the terminals can be reduced.

### Preferred Embodiment 8

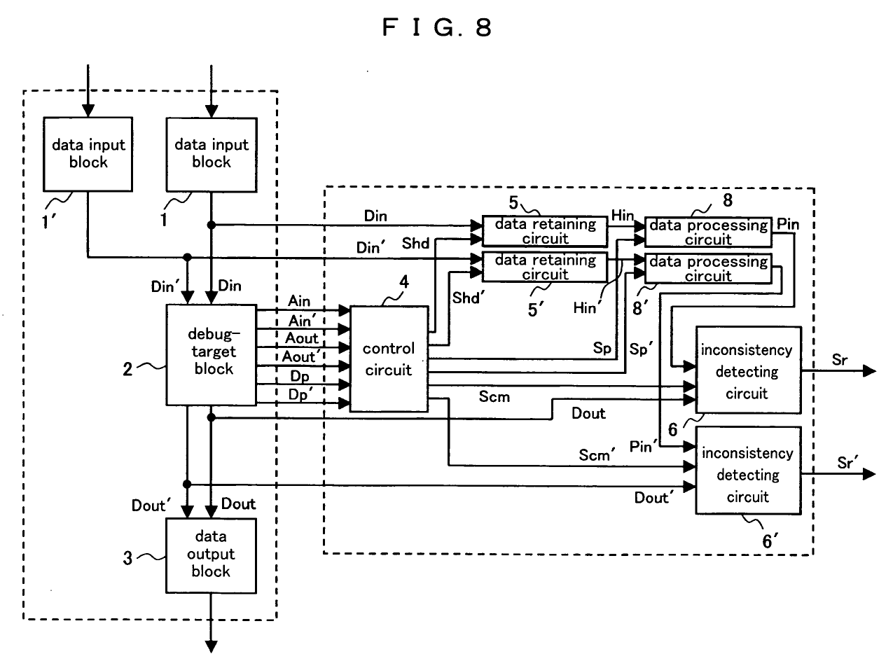

FIG. 8 is a block diagram illustrating a constitution of a bus watch circuit according to a preferred embodiment 8 of the present invention. The same reference symbols shown in FIG. 8 as those in the preferred embodiment 6 (FIG. 6) denote the same components. The constitution according to the present preferred embodiment is characterized as follows.

The preferred embodiment 8 is characterized in that a plurality of inconsistency detecting circuits (two in the drawing) are provided. The inconsistency detecting circuit 6 compares the processed data Pin outputted by the data processing circuit 8 and the output data Dout outputted by the debug-target block 2. This comparison process is performed in synchronization with the comparison timing signal Scm outputted by the control circuit 4. The inconsistency detecting circuit 6 outputs the inconsistency detection signal Sr when it is learnt from the comparison result that the two data are inconsistent. The inconsistency detecting circuit 6′ compares the processed data Pin′ outputted by the data processing circuit 8′ and the output data Dout′ outputted by the debug-target block 2 to each other. The two data are compared in synchronization with the comparison timing signal Scm′ outputted by the control circuit 4. The inconsistency detecting circuit 6′ outputs the inconsistency detection signal Sr′ when it is learnt from the comparison result that the two data are inconsistent with each other. The rest of the components, which are similar to those of the preferred embodiment 7, are not described again.

According to the present preferred embodiment, processing of a plurality of data can be watched in real time even when the plurality of input data are simultaneously data-processed by the debug-target block 2. Further, the processing result of the data processing circuit 8 on which the data processing result in the debug-target block 2 is reflected can be compared to the output data in real time. In addition to the foregoing effect wherein processing of a plurality of data can be watched in real time, a section where such a problem as garbled data arises can be easily identified without referring to the trace information, and the number of steps for analyzing the problem and the number of the terminals can be reduced.

While there has been described what is at present considered to be preferred embodiments of this invention, it will be understood that various modifications may be made therein, and it is intended to cover in the appended claims all such modifications as fall within the true spirit and scope of this invention.

What is claimed is:

1. A bus watch circuit comprising:
a debug-target block for outputting input data received from a bus as output data and generating input data effective timing information representing an effective timing of the input data and output data effective timing information representing an effective timing of the output data;
a control circuit for generating a retention timing signal representing a timing of internally retaining the input data and a comparison timing signal representing a timing of comparing the input data and the output data based on the input data effective timing information and the output data effective timing information;
a data retaining circuit for retaining the input data in synchronization with the retention timing signal; and
an inconsistency detecting circuit for judging whether or not the retained data of the data retaining circuit and the output data are consistent in synchronization with the comparison timing signal.

2. The bus watch circuit as claimed in claim 1, further comprising an access information calculating circuit for calculating latency in the debug-target block and an access frequency of the input data with respect to the debug-target block based on the retention timing signal and the comparison timing signal.

3. A bus watch circuit comprising:
a debug-target block for executing an arbitrary data processing on input data received from a bus and outputting a processing result thus obtained as output data, the debug-target block further generating input data effective timing information representing an effective timing of the input data, output data effective timing information representing an effective timing of the output data, and data processing information relating to the arbitrary data processing;
a control circuit for generating a retention timing signal representing a timing of internally retaining the input data, a comparison timing signal representing a comparison timing of the output data and a data processing control signal based on the input data effective timing information, the output data effective timing information and the data processing information;
a data retaining circuit for retaining the input data in synchronization with the retention timing signal;
a data processing circuit for executing the arbitrary data processing on the retained data of the data retaining circuit based on the data processing control signal; and
an inconsistency detecting circuit for judging whether or not the processed data of the data processing circuit and the output data are consistent in synchronization with the comparison timing signal.

4. A bus watch circuit comprising:
a debug-target block for receiving effective input data from a group of input data inputted from different buses and outputting the received input data as output data, the debug-target block further generating input data effective timing information representing an effective timing of the effective input data, output data effective timing information representing an effective timing of the output data, and effective data instruction information for instructing the effective input data in the group of input data;
a control circuit for generating a retention timing signal representing a timing of internally retaining the effective input data, a comparison timing signal representing a comparison timing of the output data and an effective data selection signal for instructing the effective input data based on the input data effective timing information, the output data effective timing information and the effective data instruction information;
a data retaining circuit for selecting and retaining the effective input data from the group of input data in synchronization with the retention timing signal based on the effective data selection signal; and
an inconsistency detecting circuit for judging whether or not the retained data of the data retaining circuit and the output data are consistent in synchronization with the comparison timing signal.

5. A bus watch circuit comprising:
a debug-target block for executing an arbitrary data processing set for each data on effective input data of a group of input data inputted from different buses and outputting a processing result thus obtained as output data, the debug-target block further generating input data effective timing information representing an effective timing of the effective input data, output data effective timing information representing an effective timing of the output data, an effective data instruction information for instructing the effective input data in the group of input data, and data processing information relating to the arbitrary data processing;
a control circuit for generating a retention timing signal representing a timing of internally retaining the effective input data, a comparison timing signal representing a comparison timing of the output data, an effective data selection signal for instructing the effective input data, and a group of data processing control signals relating to the arbitrary data processing corresponding to each of the input data based on the input data effective timing information, the output data effective timing information, the effective data instruction information, and the data processing information;
a data retaining circuit for selecting and retaining the effective input data from the group of input data in synchronization with the retention timing signal based on the effective data selection signal;
a group of data processing circuits for executing the arbitrary data processing corresponding to one of the group of input data on the retained data of the data retaining circuit based on the group of data processing control signals, the number of the group of data processing circuits provided being equal to the number of the input data constituting the group of input data; and
an inconsistency detecting circuit for judging whether or not the effective processed data of the group of processed data data-processed by the group of data processing circuits and the output data are consistent in synchronization with the comparison timing signal.

6. A bus watch circuit comprising:
a debug-target block for separately receiving each input data of a group of input data inputted from different buses and outputting the received input data as output data, the debug-target block further generating input data effective timing information representing an effective timing of each of the input data and output data effective timing information representing an effective timing of the output data;
a control circuit for generating a retention timing signal representing a timing of internally retaining the input data and a comparison timing signal representing a timing of comparing the input data and the output data for each of the input data based on the input data effective timing information and the output data effective timing information;
a group of data retaining circuits for separately retaining each of the input data in synchronization with the retention timing signal, the number of the data retaining circuits provided being equal to the number of the input data constituting the group of input data;
an inconsistency detecting circuit for judging whether or not retained data of each of the data retaining circuits and the output data are consistent in synchronization with the comparison timing signal.

7. A bus watch circuit comprising:
a debug-target block for separately receiving each input data of a group of input data inputted from different buses and outputting the received input data as a group of output data, the debug-target block further generating input data effective timing information representing an effective timing of each of the input data and output data effective timing information representing an effective timing of each of the output data;
a control circuit for generating a retention timing signal representing a timing of internally retaining the input data and a comparison timing signal representing a timing of comparing the input data and the output data for each of the input data based on the input data effective timing information and the output data effective timing information;
a group of data retaining circuits for separately retaining each of the input data in synchronization with the retention timing signal, the number of the data retaining circuits provided being equal to the number of the input data constituting the group of input data;
a group of inconsistency detecting circuits for judging whether or not the retained data of each of the data retaining circuits and the output data are consistent in synchronization with the comparison timing signal, the number of the inconsistency detecting circuits provided being equal to the number of the input data constituting the group of input data.

8. The bus watch circuit as claimed in claim 7, further comprising a group of access information calculating circuits for calculating latency in the debug-target block and an access frequency of the input data with respect to the debug-target block based on the retention timing signal and the comparison timing signal, wherein
the number of the access information calculating circuits provided corresponds to the number of the input data constituting the group of input data.

9. A bus watch circuit comprising:
a debug-target block for separately executing an arbitrary data processing on each of input data constituting a group of input data inputted from different buses and outputting a processing result thus obtained as output data, the debug-target block further generating input data effective timing information of each of the input data, output data effective timing information of the output data, and data processing information relating to the arbitrary data processing corresponding to each of the input data;
a control circuit for generating a retention timing signal representing a timing of internally retaining the input data, a comparison timing signal representing a comparison timing of the output data, and a data processing control signal relating to the arbitrary data processing corresponding to each of the input data for each of the input data based on the input data effective timing information, the output data effective timing information and the data processing information;
a group of data retaining circuits for retaining the input data in synchronization with the retention timing signal, the number of the data retaining circuits provided being equal to the number of the input data constituting the group of input data;
a group of data processing circuits for executing the arbitrary data processing on the retained data of each of the data retaining circuits based on each of the data processing control signals, the number of the data processing circuits provided being equal to the number of the input data constituting the group of input data; and
an inconsistency detecting circuit for judging whether or not the processed data of each of the data processing circuits and the output data are consistent in synchronization with the comparison timing signal.

10. A bus watch circuit comprising:
a debug-target block for separately executing an arbitrary data processing on each of input data constituting a group of input data inputted from different buses and outputting a processing result thus obtained as a group of output data for each of the input data, the debug-target block further generating input data effective timing information of each of the input data, output data effective timing information of each of the output data, and data processing information relating to the arbitrary data processing corresponding to each of the input data;
a control circuit for generating a retention timing signal representing a timing of internally retaining the input data, a comparison timing signal representing a comparison timing of the output data, and a data processing control signal relating to the arbitrary data processing corresponding to each of the input data for each of the input data based on the input data effective timing information, the output data effective timing information and the data processing information;
a group of data retaining circuits for retaining the input data in synchronization with the retention timing signal, the number of the data retaining circuits provided being equal to the number of the input data constituting the group of input data;
a group of data processing circuits for executing the arbitrary data processing to the retained data of each of the data retaining circuits based on each of the data processing control signals, the number of the data processing circuits provided being equal to the number of the input data constituting the group of input data; and
a group of inconsistency detecting circuits for judging whether or not the processed data of each of the data processing circuits and the output data are consistent in synchronization with the comparison timing signal, the number of the inconsistency detecting circuits provided being equal to the number of the input data constituting the group of input data.

11. The bus watch circuit as claimed in claim 10, further comprising a group of access information calculating circuits for calculating latency in the debug-target block and an access frequency with respect to the debug-target block based on the retention timing signal and the comparison timing signal, wherein
the number of the access information calculating circuits provided corresponds to the number of the input data constituting the group of input data.
